(19) United States
(12) Patent Application Publication
(10) Pub. No.: US 2023/0291516 A1
(43) Pub. Date: Sep. 14, 2023

(54) BIT INTERLEAVING FOR SIDELINK COMMUNICATION WITH INTERLACED WAVEFORM

(71) Applicant: QUALCOMM Incorporated, San Diego, CA (US)

(72) Inventors: Shuanshuan WU, San Diego, CA (US); Kapil GULATI, Belle Mead, NJ (US); Junyi LI, Fairless Hills, PA (US); Arthur GUBESKYS, San Diego, CA (US); Parisa CHERAGHI, Cambridge (GB); Stelios STEFANATOS, San Diego, CA (US)

(21) Appl. No.: 18/003,966

(22) PCT Filed: Jul. 30, 2021
(86) PCT No.: PCT/US2021/043891

§ 371 Date: Dec. 30, 2022

(30) Foreign Application Priority Data
Aug. 31, 2020 (GR) 20200100526

(51) Int. Cl. H04L 5/00; H04L 1/00

(52) U.S. Cl. CPC H04L 5/0046; H04L 1/0071

(57) ABSTRACT

Certain aspects of the present disclosure provide techniques for bit interleaving for sidelink communication with interlaced waveform. A method that may be performed by a user equipment (UE) includes mapping first bits and second bits to resource blocks (RBs) such that the first bits are mapped to first subcarriers of the RBs, a first subset of the second bits are mapped to the first subcarriers, and a second subset of the second bits are mapped to second subcarriers of the REs; and transmitting the first bits and the second bits via the RBs according to the mapping.

### CROSS REFERENCE TO RELATED APPLICATION

This Application hereby claims priority to Greek Application No. 20200100526, which was filed on Aug. 31, 2020, is assigned to the assignee hereof, and hereby is expressly incorporated by reference herein in its entirety as if fully set forth below and for all applicable purposes.

### BACKGROUND

### Field of the Disclosure

Aspects of the present disclosure relate to wireless communications, and more particularly, to techniques for sidelink communications.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved reliability in sidelink communications.

Certain aspects of the subject matter described in this disclosure can be implemented in a method for wireless communications by a user equipment (UE). The method generally includes mapping first bits and second bits to resource blocks (RBs) such that the first bits are mapped to first subcarriers of the RBs, a first subset of the second bits are mapped to the first subcarriers, and a second subset of the second bits are mapped to second subcarriers of the RBs; and transmitting the first bits and the second bits via the RBs according to the mapping.

Certain aspects of the subject matter described in this disclosure can be implemented in a user equipment (UE). The UE generally includes means for mapping first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs and means for transmitting the first bits and the second bits via the RBs according to the mapping.

Certain aspects of the subject matter described in this disclosure can be implemented in a user equipment (UE). The UE generally includes a processing system configured to map first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs and a transmitter configured to transmit the first bits and the second bits via the RBs according to the mapping.

Certain aspects of the subject matter described in this disclosure can be implemented in an apparatus for wireless communications. The apparatus generally includes a processing system configured to map first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs and an interface configured to output the first bits and the second bits, for transmission, via the RBs according to the mapping.

Certain aspects of the subject matter described in this disclosure can be implemented in a computer-readable medium for wireless communications. The computer-readable medium generally includes codes executable to map first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs and output the first bits and the second bits, for transmission, via the RBs according to the mapping.

Aspects of the present disclosure provide UEs, means for, apparatuses, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is an example of an interlaced subchannel, in accordance with aspects of the present disclosure.

FIG. 5 is an example graph of power output of an example transmitter over an example channel bandwidth, in accordance with aspects of the present disclosure.

FIG. 6 is an exemplary logic flow of a transmit chain, in accordance with aspects of the present disclosure.

FIG. 7 is a block diagram of an example interleaving process, in accordance with certain aspects of the present disclosure.

FIG. 8 is a block diagram of an example interleaving process, in accordance with certain aspects of the present disclosure.

FIG. 9 is a block diagram of an example interleaving process, in accordance with certain aspects of the present disclosure.

FIG. 10A is an example resource mapping of one sub-channel, in accordance with certain aspects of the present disclosure.

FIG. 10B is an example resource mapping of two sub-channels, in accordance with certain aspects of the present disclosure.

FIG. 11 is a flow diagram illustrating example operations for wireless communication by a UE, in accordance with certain aspects of the present disclosure.

FIG. 12 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

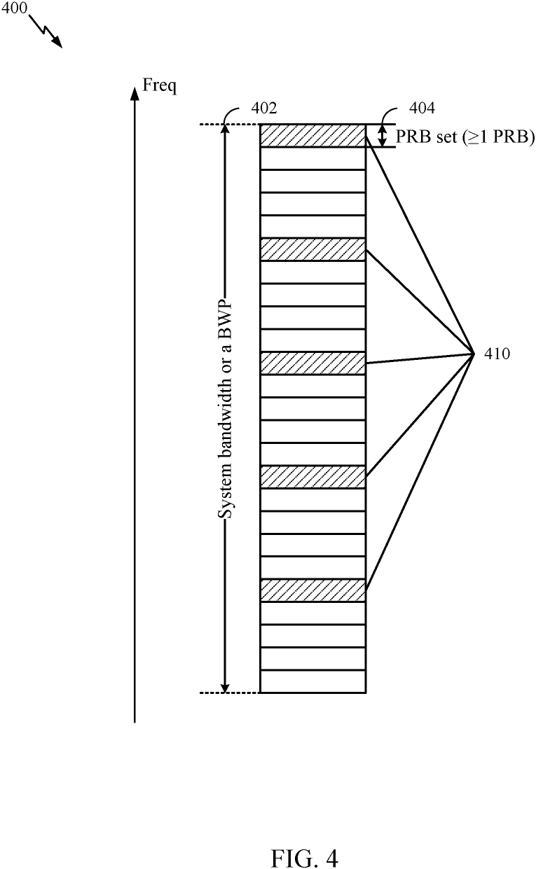

Aspects of the present disclosure provide apparatus, methods, processing systems, and computer readable mediums for bit interleaving for sidelink communication with interlaced waveform. New radio (NR) sidelink communications, such as cellular vehicle-to-everything (CV2X) communications, may be implemented in unlicensed frequency spectrum. Some regional regulations may require that more than 99% of the transmission power of a transmission on the unlicensed spectrum be distributed to at least 70% (for example, in some regions it is 80%) of the channel bandwidth in which the transmission is being made. This may be referred to as an occupied channel bandwidth (OCB) regulation. To meet the OCB regulation, LTE licensed assisted access (LAA) devices and NR in unlicensed spectrum (NR-U) devices may transmit using an interlaced waveform in which a transmission may be made on a subchannel (e.g., of the channel bandwidth) that consists of a number of physical resource blocks (PRBs) or subcarriers that are scattered in frequency in the channel bandwidth (see, e.g., subchannel 410, described with reference to FIG. 4, below). Sidelink communications may also be implemented using an interlaced waveform. However, unlike LAA and NR-U communications, a sidelink communication may be subject to a near-far effect in which a receiver of the sidelink communications (e.g., a receiving UE) may experience substantially different powers in different frequency resources within a slot, such as a higher power in transmissions from a near UE than in transmissions from a far UE.

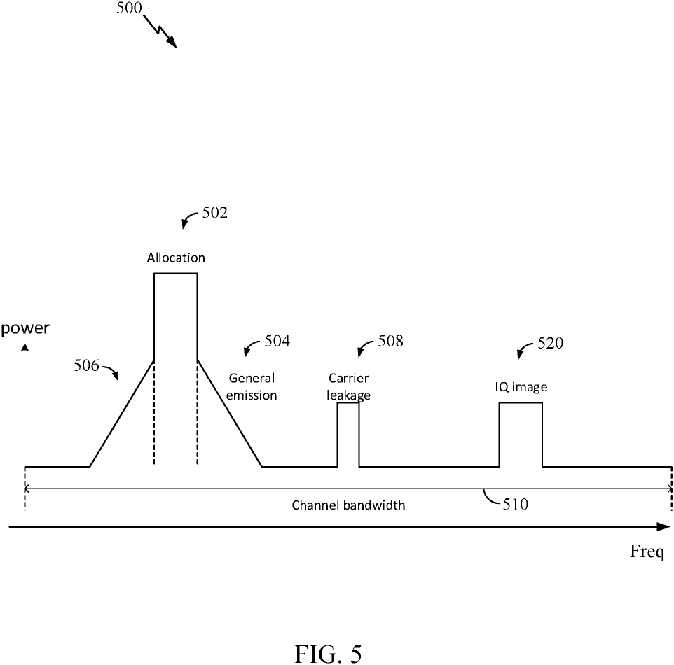

In aspects of the present disclosure, a transmitter (e.g., of a UE) may not transmit only in allocated RBs or subcarriers, but may instead transmit a majority of its transmit power in the allocated RBs or subcarriers, while a minority of power from the transmitter is in non-allocated RBs or subcarriers. The minority of power that is in non-allocated RBs or subcarriers may be referred to as in-band emission (IBE, see, e.g., FIG. 5). From a receiving UE’s perspective, IBE from a closer UE may severely interfere with a transmission from a farther UE. Interference from IBE may be more severe in RBs or subcarriers that are near a boundary of a frequency allocation, due to general emission (see, e.g., general emission 504 and 506 in FIG. 5), thus interference from IBE may be worse for transmissions using an interlaced waveform, due to the increased number of boundaries in an interlaced waveform as compared to a non-interlaced waveform.

According to aspects of the present disclosure, more important bits (e.g., systematic bits from channel encoding) may be mapped to (e.g., by an interleaving process or a resource mapping process) and transmitted in frequency resources (e.g., resource blocks (RBs) or subcarriers) that are further from a boundary in an interlaced waveform and therefore have less interference due to IBE.

The following description provides examples of bit interleaving for sidelink communication with interlaced waveform in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

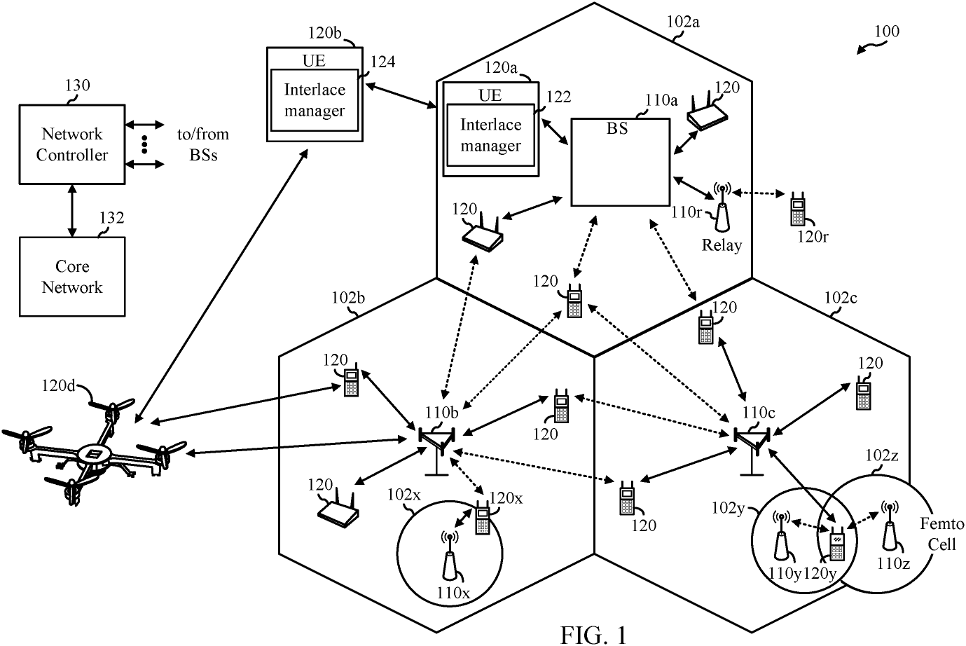

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the BSs 110 and UEs 120 may be configured for interleaving bits for an interlaced waveform. The UE 120a includes an interlace manager 122 that maps first bits (e.g., systematic bits from a coding process) and second bits (e.g., parity bits from a coding process) to resource blocks (RBs) (e.g., of an allocation of RBs for a transmission) such that the first bits are mapped to first subcarriers (e.g., central subcarriers) of the RBs, a first subset of the second bits are mapped to the first subcarriers, and a second subset of the second bits are mapped to second subcarriers (e.g., edge subcarriers near a boundary of a resource allocation) of the RBs; and transmits the first bits and the second bits via the RBs according to the mapping, in accordance with aspects of the present disclosure. The UE 120b also includes an interlace manager 124 that maps first bits (e.g., systematic bits from a coding process) and second bits (e.g., parity bits from a coding process) to resource blocks (RBs) (e.g., of an allocation of RBs for a transmission) such that the first bits are mapped to first subcarriers (e.g., central subcarriers) of the RBs, a first subset of the second bits are mapped to the first subcarriers, and a second subset of the second bits are mapped to second subcarriers (e.g., edge subcarriers near a boundary of a resource allocation) of the RBs; and transmits the first bits and the second bits via the RBs according to the mapping, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

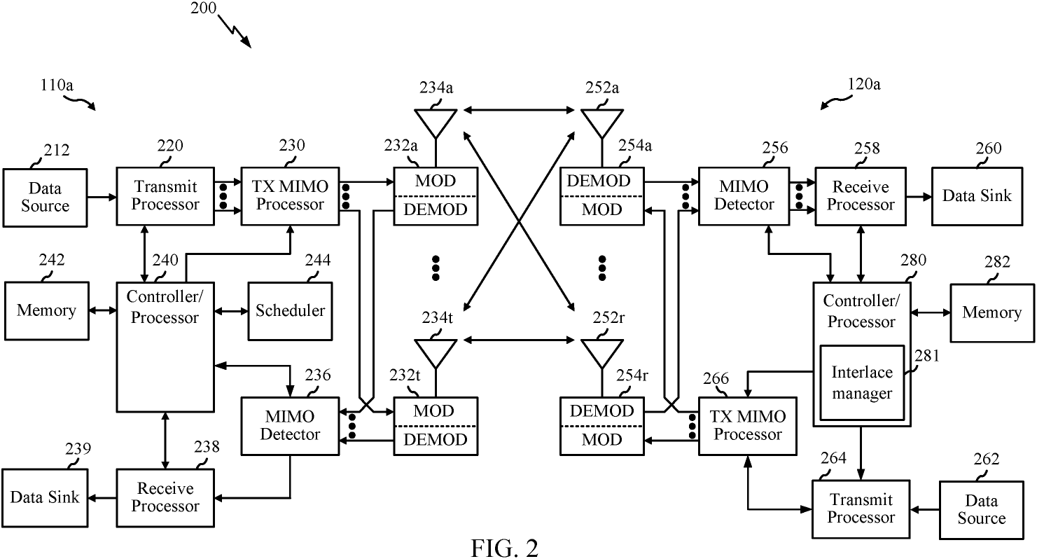

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has an interlace manager 281 that maps first bits (e.g., systematic bits from a coding process) and second bits (e.g., parity bits from a coding process) to resource blocks (RBs) (e.g., of an allocation of RBs for a transmission) such that the first bits are mapped to first subcarriers (e.g., central subcarriers) of the RBs, a first subset of the second bits are mapped to the first subcarriers, and a second subset of the second bits are mapped to second subcarriers (e.g., edge subcarriers near a boundary of a resource allocation) of the RBs; and transmits the first bits and the second bits via the RBs according to the mapping, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

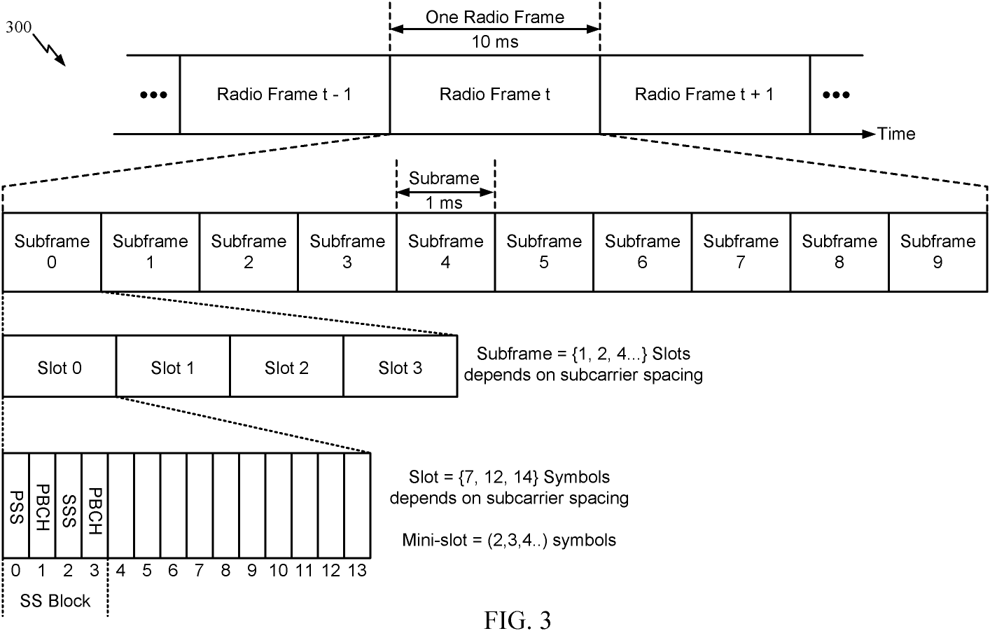

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, ... slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

FIG. 4 shows an example of an interlaced subchannel 400, in accordance with aspects of the present disclosure. A bandwidth 402, which may be a system bandwidth or a bandwidth part (BWP) bandwidth, may be divided into a plurality of physical resource block (PRB) sets that are contiguous in frequency such as PRB set 404, with each PRB set having one or more PRBs. An exemplary interlaced subchannel 410 includes five PRB sets, although the present disclosure is not so limited, and an interlaced subchannel may include two or more PRB sets.

In aspects of the present disclosure, a subchannel may consist of M1*M2 PRBs, where every M1 PRBs (M1≥1) form a PRB set which is contiguous in frequency; a subchannel has M2 PRB sets, and the PRB sets are non-contiguous (e.g., uniformly spaced) in frequency. For example, if a communications systems uses 100 PRBs for sidelink communications, and each subchannel for sidelink communications has 20 PRBs, then example combinations of (M1, M2) include (2, 10), (1, 20) and (4, 5).

FIG. 5 is an example graph 500 of power output of an example transmitter (e.g., in the UE 120a, shown in FIGS. 1 and 2) over an example channel bandwidth 510, according to aspects of the present disclosure. In the graph, the example transmitter is transmitting via an allocation 502 of frequency resources. The example transmitter also transmits in-band emission(s) (IBE) that includes general leakage 504 and 506 to adjacent non-allocated RBs, carrier leakage 508 to a center of the carrier, and IQ image leakage 520 to frequencies on the other side of the center of the carrier, mirroring the allocated RBs.

According to aspects of the present disclosure, communications using an interlaced waveform may show severe in-band emission interference in sidelink communications due, for example, to each PRB set having general emission leakage to adjacent PRBs.

In aspects of the present disclosure, IBE may completely overshadow (e.g., be received with a higher transmission power) a transmission from a remote transmitting UE, if the transmission is adjacent to another transmission (e.g., associated with the IBE) from a closer UE.

Accordingly, it is desirable to develop techniques and apparatus for mapping bits in sidelink communications using interlaced transmissions that protect more important bits from IBE.

### Example Bit Interleaving for Sidelink Communication With Interlaced Waveform

Aspects of the present disclosure provide techniques for mapping more important bits (e.g., systematic bits from channel encoding) to and transmitting the more important bits in frequency resources that are less susceptible to interference due to in-band emission. For example, edge frequency resources (e.g., subcarriers or PRBs) in a sidelink allocation (e.g., one or multiple subchannels) are usually more susceptible to interference due to IBE; thus, more important bits may not be mapped to the edge frequency resources.

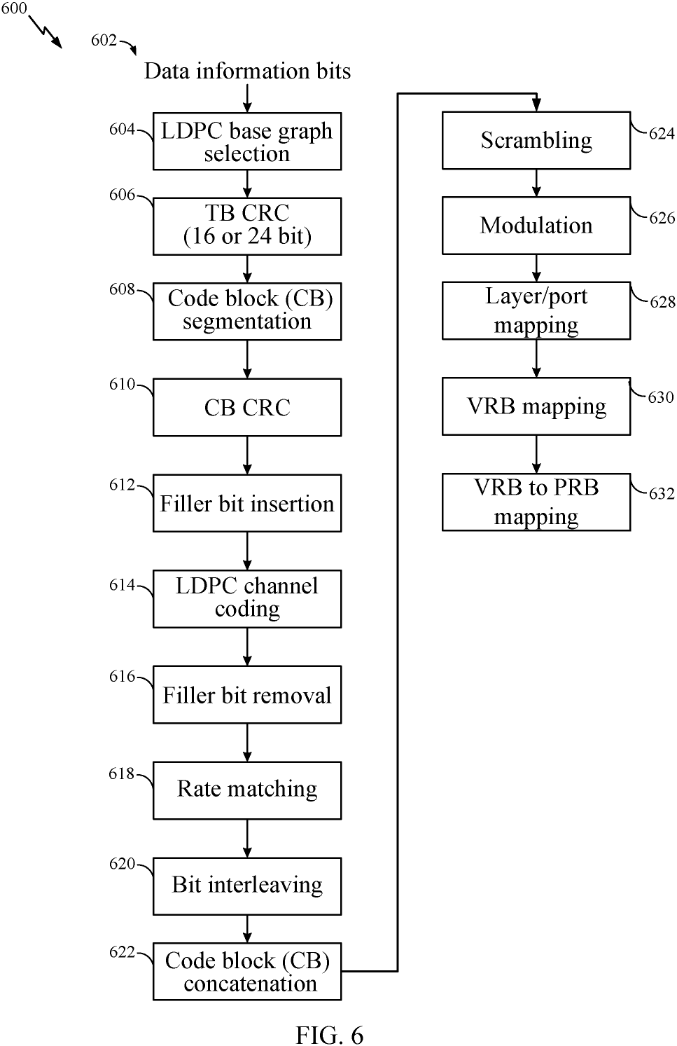

FIG. 6, shows an exemplary logic flow 600 of a transmit chain (e.g., of UE 120a, shown in FIGS. 1 and 2), in accordance with aspects of the present disclosure. The exemplary logic flow begins by obtaining data information bits at 602. The data information bits may be bits in a transport block (TB). At 604, a low density parity check (LDPC) base graph is selected, e.g., based on the number of data information bits to be transmitted. At 606, a 16-bit or 24-bit transport block (TB) cyclic redundancy check (CRC) is generated and concatenated to the transport block of data information bits. At 608, the transport block is segmented into one or more code blocks (CBs). Each of the code blocks has a code block CRC attached at 610. Filler bits are added to the one or more code blocks at 612. At 614, the code blocks are LDPC encoded based on the base graph selected in block 604. One or more of the encoded filler bits may be removed from the encoded bits at 616. At 618, an amount of encoded bits, which matches a quantity of bits to be transmitted, of a code block are read from an encoding buffer. The encoded bits are interleaved at block 620. According to some aspects of the present disclosure, the encoded bits may be interleaved in a manner that causes more important encoded bits (e.g., encoded bits that are systematic bits of the coding process) to be mapped to frequency resources (e.g., PRBs or subcarriers) that are less susceptible to interference due to IBE. At 622, the code blocks are concatenated. The concatenated code blocks are scrambled at 624. The scrambled bits are modulated on to a carrier frequency to generate symbols at 626. At 628, the symbols are mapped to layers and/or ports. The mapped symbols are mapped to virtual resource blocks (VRBs) at 630. In some aspects of the present disclosure, the symbols may be mapped to VRBs in a manner that causes more important encoded bits (e.g., encoded bits that are systematic bits of the coding process) to be mapped to frequency resources (e.g., PRBs or subcarriers) that are less susceptible to interference due to IBE. At 632, the VRBs are mapped to physical resource blocks (PRBs) for transmission.

In aspects of the present disclosure, edge (e.g., near a boundary of a frequency allocation for a transmission) PRBs or subcarriers (SCs) in a resource allocation for a physical sidelink shared channel (PSSCH) transmission may be specified as PRBs or subcarriers that are more susceptible to interference due to IBE. The edge PRBs or subcarriers may be referred to herein as vulnerable PRBs or vulnerable SCs. In an example, during TBS determination (e.g., by a transmitter), the PRBs or SCs that are more susceptible to interference due to IBE are precluded, as if those PRBs or SCs are not available for data transmission. In the example, a first TBS is determined based on the PRBs or SCs which were not precluded. In the example, while the transmit chain is performing rate matching, the vulnerable resources are taken into account, so the number of bits output from rate matching is sufficient to fill the total resource for the transmission, including the PRBs or SCs that are more susceptible to interference due to IBE. Thus, in the example, the actual coding rate (that is, the ratio of conveyed data information bits to transmitted encoded bits) may be smaller than a nominal coding rate used in TBS determination. Thus, in the example, extra parity bits are generated when rate matching is performed because the rate matching process treats the more-susceptible PRBs or SCs as being available. In the example, bit interleaving is implemented such that the extra parity bits are mapped to a set of modulation symbols separate from modulation symbols conveying systematic bits. In the example, the extra parity bits and thus, the corresponding modulation symbols, are mapped to and transmitted in more-susceptible PRBs or SCs.

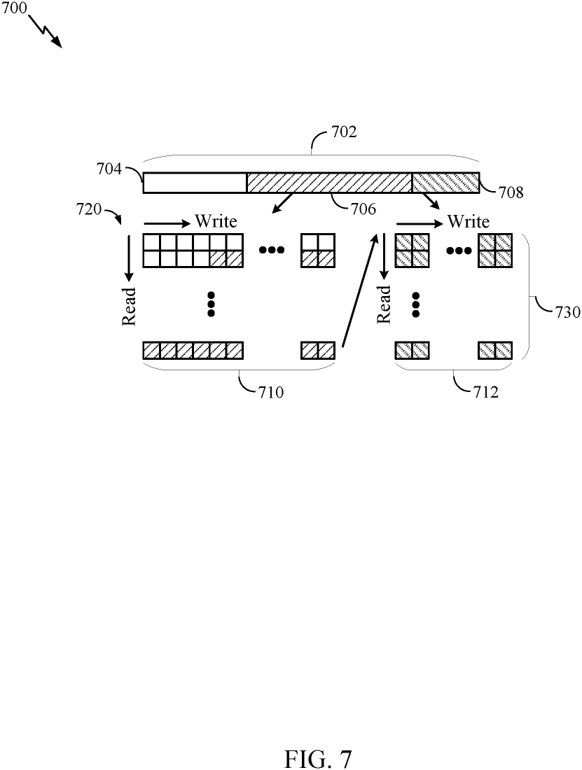

FIG. 7 is a block diagram 700 of an example interleaving process, according to aspects of the present disclosure. In the example interleaving process, the bits from rate matching that are in an allocation for the transmission are represented at 710 and 712. The bits that are more susceptible to interference due to IBE are represented at 712. That is, each of the columns of bits shown at 710 and 712 may form a modulation symbol (e.g., during modulation 626 in FIG. 6) for transmission, and the modulation symbols from the columns at 710 are mapped (e.g., during one or a combination of layer/port mapping 628, VRB mapping 630, and VRB to PRB mapping 632 in FIG. 6) to PRBs or SCs that are less susceptible to interference due to IBE, while the modulation symbols from the columns at 712 are mapped (e.g., during one or a combination of layer/port mapping 628, VRB mapping 630, and VRB to PRB mapping 632 in FIG. 6) to PRBs or SCs that are more susceptible to interference due to IBE. Bits from a rate matching process (e.g., performed by a transmitter) are represented at 702. The bits from the rate matching process include first bits (e.g., systematic bits) 704 and second bits (e.g., parity bits) 706 and 708. In the example interleaving process, a TBS is determined based on the resources at 710 (e.g., total number of modulation symbols or resource elements in PRBs or SCs that are less susceptible to interference from IBE, precluding the PRBs or SCs that are more susceptible to interference due to IBE at 712). In the example interleaving process, the first bits and a first subset 706 of the second bits, determined according to the TBS, are written (e.g., to a transmit buffer) at 720 such that the first bits and the first subset of the second bits will be mapped to the PRBs or SCs that are less susceptible to interference due to IBE at 710. In some examples, the first subset 706 may be empty; that is, in some examples only first bits are written (e.g., to the transmit buffer) at 720 such that the first bits will be mapped to the PRBs or SCs that are less susceptible to interference due to IBE at 710. In the example interleaving process, a second subset 708 of the second bits are written (e.g., to the transmit buffer) such that the second subset of the second bits will be mapped to the precluded PRBs or SCs at 712. The number of rows 730 used in the interleaving process may be determined based on a modulation order (Qₘ) for the transmission. Each column of bits at 710 and 712 may form a modulation symbol, with the number of modulation symbols and number of columns at 710 determined based on a quantity of RBs or SCs less susceptible to interference due to IBE and the number of modulation symbols and number of columns at 712 determined based on a quantity of RBs or SCs more susceptible to interference due to IBE.

According to aspects of the present disclosure, edge PRBs or subcarriers (SCs) in a resource allocation for a physical sidelink shared channel (PSSCH) transmission may be specified as PRBs or subcarriers that are more susceptible to interference due to IBE. In an example, during TBS determination (e.g., by a transmitter), the PRBs or SCs that are more susceptible to interference due to IBE are precluded, as if those PRBs or SCs are not available for data transmission. In the example, in rate matching, the vulnerable resources are also excluded, i.e., the number of bits output from rate matching is the number of bits that can be transmitted in the resources excluding the vulnerable PRBs or SCs. Those bits are then interleaved. In the example, another set of bits (e.g., extra parity bits) are selected from channel coding output. In the example, modulation symbols corresponding to the other set of bits are mapped to vulnerable PRBs or SCs. Thus, the vulnerable resources are used for transmission of the extra parity bits. In the example, the actual coding rate (that is, the ratio of conveyed data information bits to transmitted encoded bits) may be smaller than a nominal coding rate used in TBS determination. In the example, the extra parity bits may be or may not be interleaved.

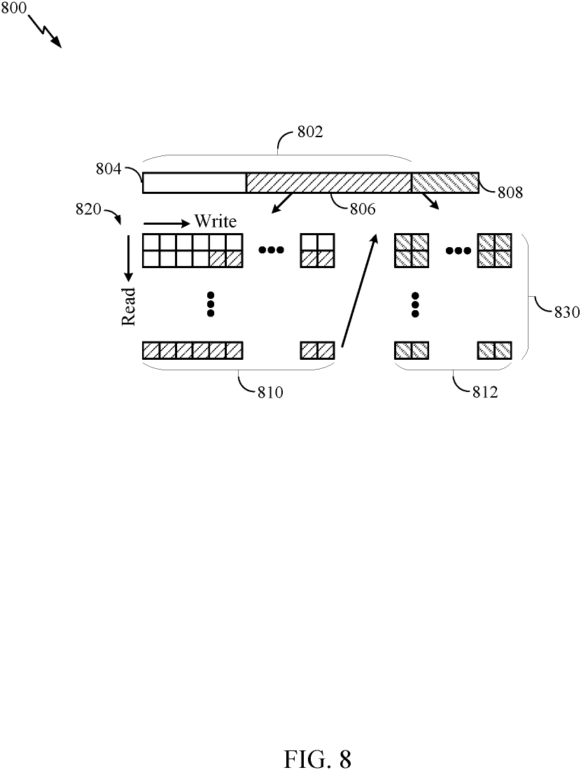

FIG. 8 is a block diagram 800 of an example interleaving process, according to aspects of the present disclosure. In the example interleaving process, PRBs or SCs that are in an allocation for the transmission are represented at 810 and 812. PRBs or SCs that are more susceptible to interference due to IBE are represented at 812. That is, each of the columns of bits shown at 810 and 812 may form a modulation symbol (e.g., during modulation 626 in FIG. 6) for transmission, and the modulation symbols from the columns at 810 are mapped (e.g., during one or a combination of layer/port mapping 628, VRB mapping 630, and VRB to PRB mapping 632 in FIG. 6) to PRBs or SCs that are less susceptible to interference due to IBE, while the modulation symbols from the columns at 812 are mapped (e.g., during one or a combination of layer/port mapping 628, VRB mapping 630, and VRB to PRB mapping 632 in FIG. 6) to PRBs or SCs that are more susceptible to interference due to IBE. Bits from a rate matching process (e.g., performed by a transmitter) are represented at 802 and 808. The bits from the rate matching process include first bits (e.g., systematic bits) 804 and second bits (e.g., parity bits) 806 and 808. In the example interleaving process, a TBS is determined based on the PRBs or SCs at 810 and 812. In the example interleaving process, the first bits and a first subset 806 of the second bits, determined according to rate matching that is performed based on the PRBs or SCs at 810, are written (e.g., to a transmit buffer) at 820. In some examples, the first subset 806 may be empty; that is, in some examples only first bits are written (e.g., to the transmit buffer) at 820 such that the first bits will be mapped to the PRBs or SCs that are less susceptible to interference due to IBE at 810. Because the rate matching is performed based on the PRBs or SCs at 810 and precluding the SCs or PRBs at 812, the first bits and the first subset of the second bits will be mapped to the PRBs or SCs that are less susceptible to interference due to IBE at 810. In the example interleaving process, a second subset 808 of the second bits are selected from the encoding process (e.g., the encoding process that supplied the bits for the rate matching) and written to the buffer (e.g., to the transmit buffer) such that the second subset of the second bits will be mapped to the precluded PRBs or SCs at 812. When read for transmission, the second subset of the second bits may optionally be read in the same order that they were written, i.e., without being interleaved. The number of rows 830 used in the interleaving process is determined based on a modulation order (Qₘ) for the transmission. Each column of bits at 810 and 812 may form a modulation symbol, with the number of modulation symbols and number of columns at 810 determined based on a quantity of RBs or SCs less susceptible to interference due to IBE and the number of modulation symbols and number of columns at 812 determined based on a quantity of RBs or SCs more susceptible to interference due to IBE.

In aspects of the present disclosure, edge (e.g., near a boundary of a frequency allocation for a transmission) PRBs or subcarriers (SCs) in a resource allocation for a physical sidelink shared channel (PSSCH) transmission may be specified as PRBs or subcarriers that are more susceptible to interference due to IBE. In an example of bit interleaving, the total bits from a rate matching output (i.e., for a CB) may be fragmented into two sets, Set-1 and Set-2. In the example, Set-1 has a majority of the systematic bits (e.g., all of the systematic bits), while Set-2 has few (e.g., zero) systematic bits and is mostly (e.g., only) parity bits. In the example during VRB mapping, modulation symbols generated from the bits in Set-1 will be mapped to virtual resources (e.g., virtual resource blocks (VRBs)) such that these virtual resources will be mapped to physical resources (e.g., physical resource blocks (PRBs)) that are less susceptible to interference due to IBE. The modulation symbols generated from the bits from Set-2 will be mapped to virtual resources such that these virtual resources will be mapped to physical resources that are more susceptible to interference due to IBE.

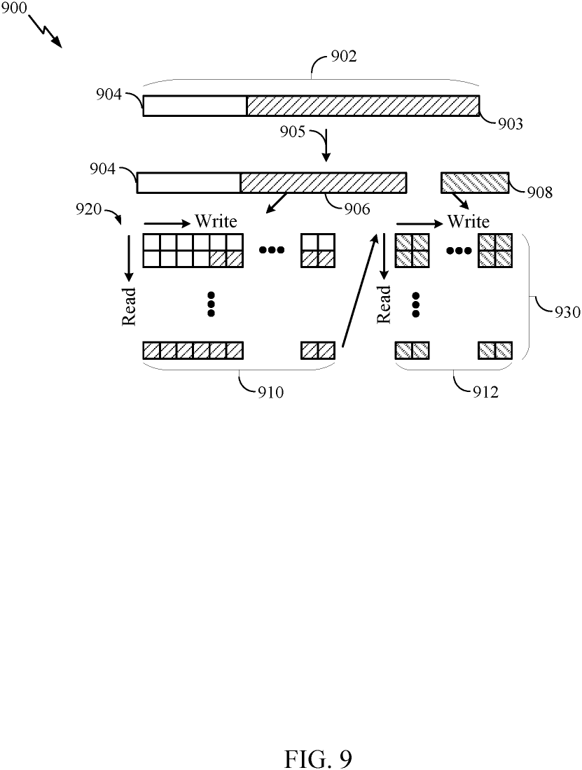

FIG. 9 is a block diagram 900 of an example interleaving process, according to aspects of the present disclosure. In the example interleaving process, PRBs or SCs that are in an allocation for the transmission are represented at 910 and 912. PRBs or SCs that are more susceptible to interference due to IBE are represented at 912. Bits from a rate matching process (e.g., performed by a transmitter) are represented at 902. The bits from the rate matching process includes first bits (e.g., systematic bits) 904 and second bits (e.g., parity bits) 903. In the example interleaving process, the bits from the rate matching process are segmented at 905 into a first set (e.g., Set-1, described above) that includes all of the first bits 904 and a first subset 906 of the second bits 903 and a second set (e.g., Set-2, described above) that includes none of the first bits and a second subset 908 of the second bits 903. In the example interleaving process, the first set of bits (i.e., the first bits 904 and the first subset 906 of the second bits) are written (e.g., to a transmit buffer) at 920 such that the first bits and the first subset of the second bits will be mapped to the PRBs or SCs that are less susceptible to interference due to IBE at 910. In some examples, the first subset 906 may be empty; that is, in some examples only first bits are written (e.g., to the transmit buffer) at 920 such that the first bits will be mapped to the PRBs or SCs that are less susceptible to interference due to IBE at 910. In the example interleaving process, the second subset 908 of the second bits are written (e.g., to the transmit buffer) such that the second subset of the second bits will be mapped to the precluded PRBs or SCs at 912. The number of rows 930 used in the interleaving process is determined based on a modulation order (Qₘ) for the transmission. Each column of bits at 910 and 912 may form a modulation symbol, with the number of modulation symbols and number of columns at 910 determined based on a quantity of RBs or SCs less susceptible to interference due to IBE and the number of modulation symbols and number of columns at 912 determined based on a quantity of RBs or SCs more susceptible to interference due to IBE.

According to aspects of the present disclosure, mapping of modulation symbols to VRBs or resource elements (REs) may be in a frequency-first manner. That is, modulation symbols are mapped across the relevant frequencies in a period before the mapping process moves to a next period and maps modulation symbols across the relevant frequencies in that next period.

In aspects of the present disclosure, mapping of modulation symbols from Set-1 and Set-2 may be performed separately (for example, when mapping modulation symbols <from Set-1> to a grid of virtual resources, virtual resource corresponding to resources more susceptible to interference due to IBE may be excluded).

According to aspects of the present disclosure, VRB to PRB mapping may be a one-to-one mapping.

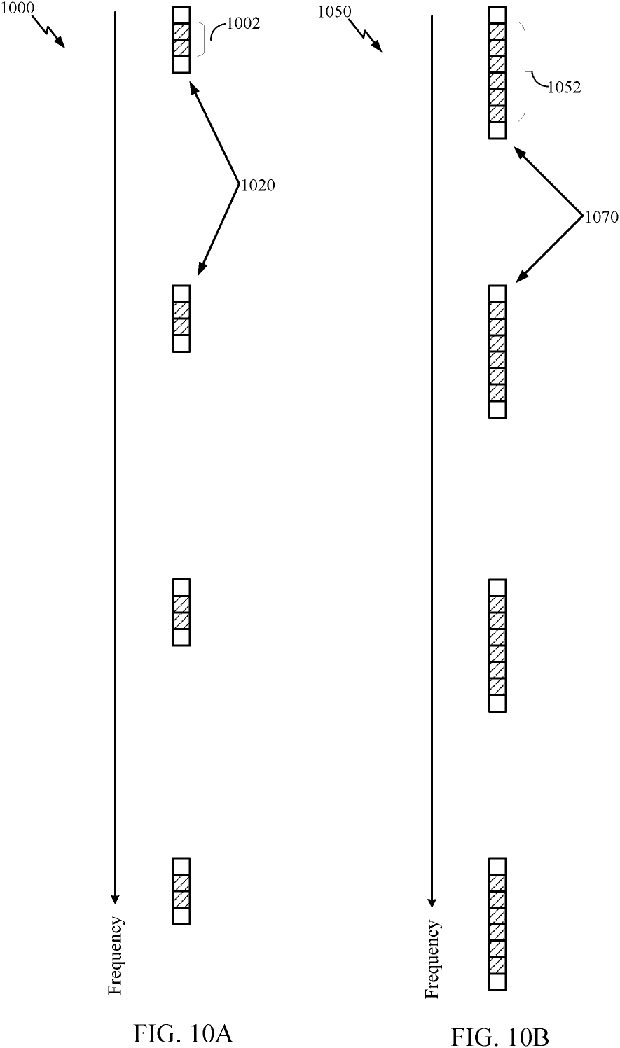

FIG. 10A is an example resource mapping 1000, in accordance with certain aspects of the present disclosure. In the example resource mapping, one sub-channel is allocated for a transmission. In the sub-channel, the two edge PRBs in each PRB set are shown without cross-hatching, with examples indicated at 1020. In aspects of the present disclosure, the two edge PRBs in each PRB set may be specified as resources more susceptible to interference due to IBE and, for example, precluded from consideration at some steps of an interleaving process, as described above with reference to FIGS. 7-9. In the sub-channel, the two central PRBs in each PRB set are shown with cross-hatching, with an example indicated at 1002.

FIG. 10B is an example resource mapping 1050, in accordance with certain aspects of the present disclosure. In the example resource mapping, two sub-channels are allocated for a transmission. In the two sub-channels, the two edge PRBs in each PRB set are shown without cross-hatching, with examples indicated at 1070. In aspects of the present disclosure, the two edge PRBs in each PRB set may be specified as resources more susceptible to interference due to IBE and, for example, precluded from consideration at some steps of an interleaving process, as described above with reference to FIGS. 7-9. In the two sub-channel, the six central PRBs in each PRB set are shown with cross-hatching, with an example indicated at 1052.

According to aspects of the present disclosure, a number (e.g., 1, 2, or 3) of edge subcarriers in edge PRBs may be specified as resources more susceptible to interference due to IBE and, for example, precluded from consideration at some steps of an interleaving process, as described above with reference to FIGS. 7-9.

In aspects of the present disclosure, CB concatenation (e.g., if multiple CBs transmitted) may be performed separately for the two sets of bits, i.e., concatenate bits from Set-1 of each CB, and concatenate bits from Set-2 of each CB.

According to aspects of the present disclosure, after modulation, VRB mapping or RE mapping for modulation symbols from the two sets of bits can be performed separately, as discussed above with reference to FIGS. 7-9.

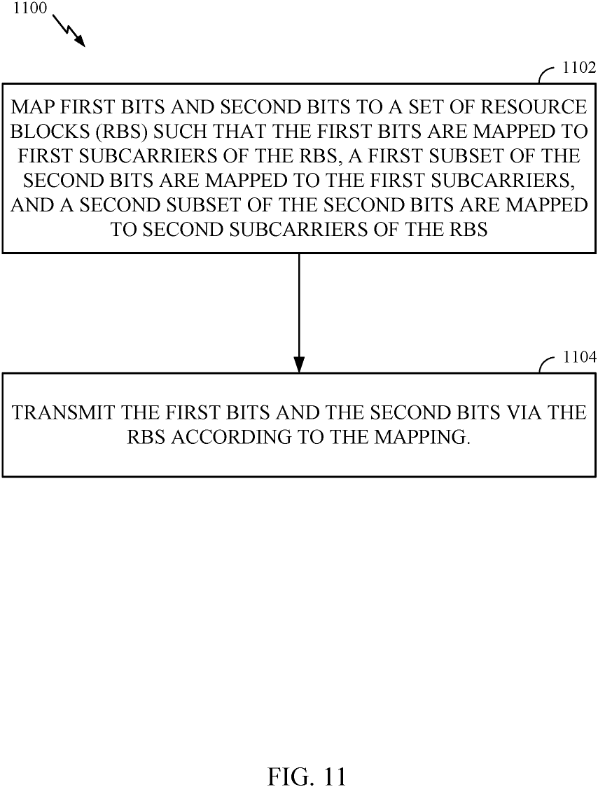

FIG. 11 is a flow diagram illustrating example operations 1100 for wireless communication, in accordance with certain aspects of the present disclosure. The operations 1100 may be performed, for example, by a UE (e.g., the UE 120a in the wireless communication network 100). The operations 1100 may be implemented as software components that are executed and run on one or more processors (e.g., controller/processor 280 of FIG. 2). Further, the transmission and reception of signals by the UE in operations 1100 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1100 may begin, at 1102, by mapping first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs.

Operations 1100 continue at 1104 by transmitting the first bits and the second bits via the RBs according to the mapping.

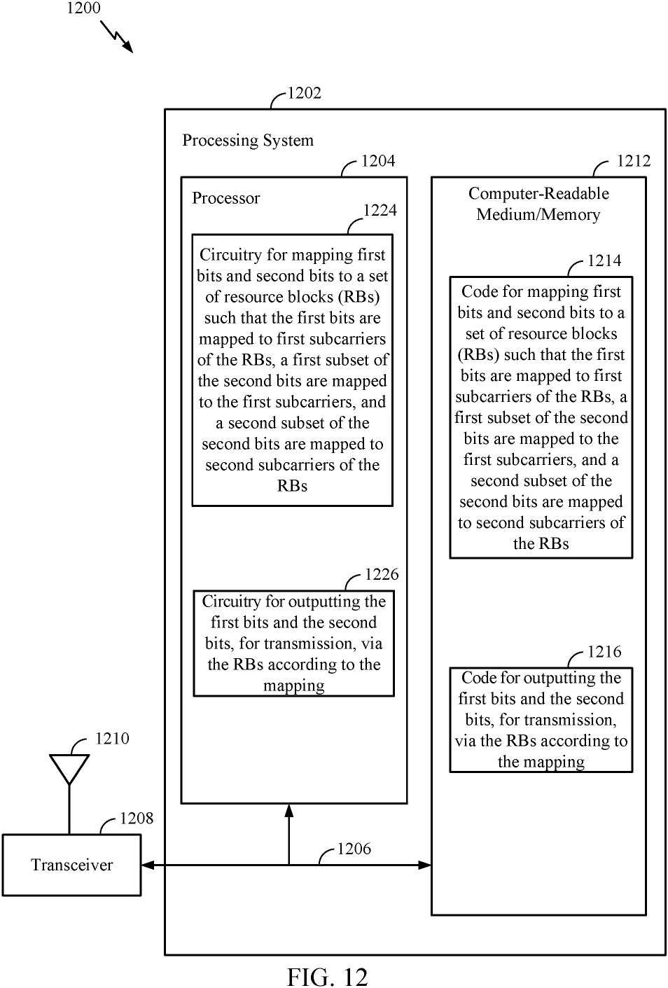

FIG. 12 illustrates a communications device 1200 that may include various components (e.g., corresponding to means-plus-function components) configured to perform operations for the techniques disclosed herein, such as the operations illustrated in FIG. 11. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 11, or other operations for performing the various techniques discussed herein for bit interleaving for sidelink communication with interlaced waveform. In certain aspects, computer-readable medium/memory 1212 stores code 1214 for mapping first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and code 1216 for outputting the first bits and the second bits, for transmission, via the RBs according to the mapping. In certain aspects, the processor 1204 has circuitry configured to implement the code stored in the computer-readable medium/memory 1212. The processor 1204 includes circuitry (e.g., an example of means for) 1224 for mapping first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and circuitry (e.g., an example of means for) 1226 for outputting the first bits and the second bits, for transmission, via the RBs according to the mapping. One or more of circuitry 1224 and 1226 may be implemented by one or more of a digital signal processor (DSP), a circuit, an application specific integrated circuit (ASIC), or a processor (e.g., a general purpose or specifically programmed processor).

### Example Aspects

Aspect 1: A method of wireless communication by a user equipment (UE), comprising: mapping first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and transmitting the first bits and the second bits via the RBs according to the mapping.

Aspect 2: The method of Aspect 1, wherein the first bits comprise systematic bits and the second bits comprise parity bits.

Aspect 3: The method of one of Aspects 1-2, wherein the set of RBs comprise RBs used for a data channel transmission comprising the first bits and the second bits and wherein the RBs have an interlaced structure.

Aspect 4: The method of one of Aspects 1-3, wherein the mapping comprises: determining a first transport block size (TBS) based on the first subcarriers; and interleaving the first bits and the first subset of the second bits on the first subcarriers according to the first TBS.

Aspect 5: The method of Aspect 4, wherein the first TBS is determined for the first bits and the first subset of the second bits.

Aspect 6: The method of Aspect 4, wherein the mapping further comprises: determining a second TBS based on the first subcarriers and the second subcarriers; and interleaving the second subset of the second bits on the second subcarriers according to the second TBS.

Aspect 7: The method of Aspect 6, wherein the second TBS is determined for the first bits and the second bits.

Aspect 8: The method of one of Aspects 1-7, wherein the mapping comprises: mapping the first bits and the first subset of the second bits to first RBs of the RBs; and mapping the second subset of the second bits to second RBs of the RBs.

Aspect 9: The method of Aspect 8, wherein the first RBs comprise first virtual resource blocks (VRBs), the second RBs comprise second VRBs, and the mapping further comprises: mapping the first VRBs to first physical resource blocks (PRBs) corresponding to the first subcarriers; and mapping the second VRBs to second PRBs corresponding to the second subcarriers.

Aspect 10: The method of Aspect 8, wherein the second RBs comprise second physical resource blocks (PRBs) adjacent, in frequency, to third PRBs; and the first RBs comprise first PRBs adjacent, in frequency, only to the second PRBs and not adjacent in frequency to the third RBs.

Aspect 11: The method of one of Aspects 1-9, wherein the mapping comprises: determining a transport block size (TBS) based on the first subcarriers and the second subcarriers; and interleaving the first bits and the first subset of the second bits on the first subcarriers according to the TBS.

Aspect 12: The method of Aspect 10, wherein the TBS is determined for the first bits and the second bits.

Aspect 13: The method of Aspect 10, wherein the mapping further comprises: interleaving the second subset of the second bits on the second subcarriers according to the TBS.

Aspect 14: The method of one of Aspects 1-12, wherein the mapping comprises: fragmenting bits from a rate matching output into: a first set of bits that includes the first bits and the first subset of the second bits; and a second set of bits that includes the second subset of the second bits; interleaving the first set of bits on the first subcarriers; and interleaving the second set of bits on the second subcarriers.

Aspect 15: The method of one of Aspects 1-13, further comprising: receiving total bits from a rate matching process, wherein the total bits comprise the first bits and the second bits.

Aspect 16: The method of Aspect 14, wherein the mapping comprises: fragmenting the total bits into: a first set of bits that includes the first bits and the first subset of the second bits; and a second set of bits that includes the second subset of the second bits; mapping the first set of bits to first RBs of the RBs; and mapping the second set of bits to second RBs of the RBs.

Aspect 17: The method of Aspect 15, wherein the first RBs comprise first virtual resource blocks (VRBs), the second RBs comprise second VRBs, and the mapping further comprises: mapping the first VRBs to first physical resource blocks (PRBs) corresponding to the first subcarriers; and mapping the second VRBs to second PRBs corresponding to the second subcarriers.

Aspect 18: A user equipment, comprising means for performing one or more of the methods of Aspects 1-16.

Aspect 19: A user equipment, comprising: a processing system; and a transmitter, the processing system and the transmitter configured to perform the method of one or more of Aspects 1-16.

Aspect 20: An apparatus for wireless communications, comprising: a processing system configured to map first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and an interface configured to output the first bits and the second bits, for transmission, via the RBs according to the mapping.

Aspect 21: A computer-readable medium for wireless communications, comprising codes executable by an apparatus to: map first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and output the first bits and the second bits, for transmission, via the RBs according to the mapping.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, processors 258, 264 and 266, and/or controller/processor 280 of the UE 120a and/or processors 220, 230, 238, and/or controller/processor 240 of the BS 110a shown in FIG. 2 may be configured to perform operations 1100 of FIG. 11.

Means for receiving may include a transceiver, a receiver or at least one antenna and at least one receive processor illustrated in FIG. 2. Means for transmitting, means for sending or means for outputting may include, a transceiver, a transmitter or at least one antenna and at least one transmit processor illustrated in FIG. 2. Means for mapping, means for performing, means for determining, means for interleaving, and means for fragmenting may include a processing system, which may include one or more processors, such as processors 258, 264 and 266, and/or controller/processor 280 of the UE 120a and/or processors 220, 230, 238, and/or controller/processor 240 of the BS 110a shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 11.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
mapping first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and
transmitting the first bits and the second bits via the RBs according to the mapping.

2. The method of claim 1, wherein, at least one of:
the first bits comprise systematic bits and the second bits comprise parity bits;
the set of RBs comprise RBs used for a data channel transmission comprising the first bits and the second bits and wherein the RBs have an interlaced structure; or
the mapping comprises:
fragmenting bits from a rate matching output into a first set of bits that includes the first bits and the first subset of the second bits, and a second set of bits that includes the second subset of the second bits,
interleaving the first set of bits on the first subcarriers, and
interleaving the second set of bits on the second subcarriers.

3. The method of claim 1, wherein the mapping comprises:
determining a first transport block size (TBS) based on the first subcarriers; and
interleaving the first bits and the first subset of the second bits on the first subcarriers according to the first TBS.

4. The method of claim 3, wherein the first TBS is determined for the first bits and the first subset of the second bits.

5. The method of claim 3, wherein the mapping further comprises:
determining a second TBS based on the first subcarriers and the second subcarriers; and
interleaving the second subset of the second bits on the second subcarriers according to the second TBS.

6. The method of claim 5, wherein the second TBS is determined for the first bits and the second bits.

7. The method of claim 1, wherein the mapping comprises:
mapping the first bits and the first subset of the second bits to first RBs of the set of RBs; and
mapping the second subset of the second bits to second RBs of the set of RBs.

8. The method of claim 7, wherein the first RBs comprise first virtual resource blocks (VRBs), the second RBs comprise second VRBs, and the mapping further comprises:
mapping the first VRBs to first physical resource blocks (PRBs) corresponding to the first subcarriers; and
mapping the second VRBs to second PRBs corresponding to the second subcarriers.

9. The method of claim 7, wherein:
the second RBs comprise second physical resource blocks (PRBs) adjacent, in frequency, to third PRBs; and
the first RBs comprise first PRBs adjacent, in frequency, only to the second PRBs and not adjacent in frequency to the third RBs.

10. The method of claim 1, wherein the mapping comprises:
determining a transport block size (TBS) based on the first subcarriers and the second subcarriers; and
interleaving the first bits and the first subset of the second bits on the first subcarriers according to the TBS.

11. The method of claim 10, wherein the TBS is determined for the first bits and the second bits.

12. The method of claim 10, wherein the mapping further comprises:
interleaving the second subset of the second bits on the second subcarriers according to the TBS.

13. The method of claim 1, further comprising:
receiving total bits from a rate matching process, wherein the total bits comprise the first bits and the second bits.

14. The method of claim 13, wherein the mapping comprises:
fragmenting the total bits into:
a first set of bits that includes the first bits and the first subset of the second bits; and
a second set of bits that includes the second subset of the second bits;
mapping the first set of bits to first RBs of the set of RBs; and
mapping the second set of bits to second RBs of the set of RBs.

15. The method of claim 14, wherein the first RBs comprise first virtual resource blocks (VRBs), the second RBs comprise second VRBs, and the mapping further comprises:
mapping the first VRBs to first physical resource blocks (PRBs) corresponding to the first subcarriers; and
mapping the second VRBs to second PRBs corresponding to the second subcarriers.

16. A user equipment (UE), comprising:
a processing system configured to map first bits and second bits to a set of resource blocks (RBs) such that the first bits are mapped to first subcarriers of the RBs, a first subset of the second bits are mapped to the first subcarriers, and a second subset of the second bits are mapped to second subcarriers of the RBs; and
a transmitter configured to transmit the first bits and the second bits via the RBs according to the mapping.

17. The UE of claim 16, wherein, at least one of:
the first bits comprise systematic bits and the second bits comprise parity bits;
the set of RBs comprise RBs used for a data channel transmission comprising the first bits and the second bits and wherein the RBs have an interlaced structure; or
the mapping comprises:
fragmenting bits from a rate matching output into a first set of bits that includes the first bits and the first subset of the second bits, and a second set of bits that includes the second subset of the second bits,
interleaving the first set of bits on the first subcarriers, and
interleaving the second set of bits on the second subcarriers.

18. The UE of claim 16, wherein the mapping comprises:
determining a first transport block size (TBS) based on the first subcarriers; and
interleaving the first bits and the first subset of the second bits on the first subcarriers according to the first TBS.

19. The UE of claim 18, wherein the first TBS is determined for the first bits and the first subset of the second bits.

20. The UE of claim 18, wherein the mapping further comprises:
determining a second TBS based on the first subcarriers and the second subcarriers; and
interleaving the second subset of the second bits on the second subcarriers according to the second TBS.

21. The UE of claim 20, wherein the second TBS is determined for the first bits and the second bits.

22. The UE of claim 16, wherein the mapping comprises:
mapping the first bits and the first subset of the second bits to first RBs of the set of RBs; and
mapping the second subset of the second bits to second RBs of the set of RBs.

23. The UE of claim 22, wherein the first RBs comprise first virtual resource blocks (VRBs), the second RBs comprise second VRBs, and the mapping further comprises:
mapping the first VRBs to first physical resource blocks (PRBs) corresponding to the first subcarriers; and
mapping the second VRBs to second PRBs corresponding to the second subcarriers.

24. The UE of claim 22, wherein:
the second RBs comprise second physical resource blocks (PRBs) adjacent, in frequency, to third PRBs; and
the first RBs comprise first PRBs adjacent, in frequency, only to the second PRBs and not adjacent in frequency to the third RBs.

25. The UE of claim 16, wherein the mapping comprises:
determining a transport block size (TBS) based on the first subcarriers and the second subcarriers; and
interleaving the first bits and the first subset of the second bits on the first subcarriers according to the TBS.

26. The UE of claim 25, wherein the TBS is determined for the first bits and the second bits.

27. The UE of claim 25, wherein the mapping further comprises:
interleaving the second subset of the second bits on the second subcarriers according to the TBS.

28. The UE of claim 16, further comprising:
receiving total bits from a rate matching process, wherein the total bits comprise the first bits and the second bits.

29. The UE of claim 28, wherein the mapping comprises:
fragmenting the total bits into:
a first set of bits that includes the first bits and the first subset of the second bits; and
a second set of bits that includes the second subset of the second bits;
mapping the first set of bits to first RBs of the set of RBs; and
mapping the second set of bits to second RBs of the set of RBs.

30. The UE of claim 29, wherein the first RBs comprise first virtual resource blocks (VRBs), the second RBs comprise second VRBs, and the mapping further comprises:
mapping the first VRBs to first physical resource blocks (PRBs) corresponding to the first subcarriers; and
mapping the second VRBs to second PRBs corresponding to the second subcarriers.
